(19) United States
(12) Patent Application Publication
(10) Pub. No.: US 2012/0180557 A1
(43) Pub. Date: Jul. 19, 2012

(54) SURFACE PROCESSING APPARATUS

(75) Inventors: Yoshinori Nakano, Kyoto-shi (JP); Satoshi Mayumi, Kyoto-shi (JP); Kenichiro Miyasato, Kyoto-shi (JP); Takashi Yoshizawa, Osaka-shi (JP); Yutaka Miyajima, Osaka-shi (JP)

(73) Assignees: SHARP KABUSHIKI KAISHA, Osaka (JP); SEKISUI CHEMICAL CO., LTD., Osaka (JP)

(21) Appl. No.: 13/006,249

(22) Filed: Jan. 13, 2011

(51) Int. Cl. G01B 5/28

(52) U.S. Cl. 73/105

(57) ABSTRACT

The present invention relates to an apparatus 1 that processes a surface of a substrate 9 to be processed. A processing module 3 is disposed so as to oppose the substrate 9. The processing module 3 is relatively moved with respect to the substrate 9 in a direction of movement parallel to a plane PL. A foreign matter on the surface of the substrate 9 or a raised portion of the surface is detected by the detection mechanism 10. A roller 12, preferably having a circular cylindrical configuration, of the detection mechanism 10 is disposed in the processing module 3. A rotation axis 12a of the roller 12 is parallel to the plane PL and intersects the direction of movement. The roller 12 is supported by a supporter 13 such that the roller 12 can be rotated about the rotation axis 12a. The rotation axis 12a is adapted to be displaceable in a direction intersecting the plane PL. Rotation of the roller 12 is detected by a rotation sensor 21.

### BACKGROUND OF THE INVENTION

1. Field of the Invention

The present invention relates to an apparatus that processes a surface of an substrate to be processed, and more particularly to a surface processing apparatus including a system for detecting foreign matters on the surface of the substrate or raised portions of the substrate during surface processing.

2. Description of Related Art

Apparatus that processes a surface of a substrate by ejecting processing fluid from a processing module while relatively moving the substrate with respect to a processing module are well known in the art (see Japan Patent Application Publication No. 2000-24571 (referred to as “Document 1” hereinafter) and Japan Patent Application Publication No. 2002-1195 (referred to as “Document 2” hereinafter), for example). In this kind of surface processing apparatus, a gap between the processing module and the substrate is often set to be narrow to secure homogeneity and stability of processing. Therefore, if there is a foreign matter on the surface of the substrate or a portion of the substrate is raised due to a foreign matter caught between the substrate and a placement table, it is probable that the processing module may be contacted with the foreign matter or the raised portion. Such a contact may cause the processing module or the substrate to be damaged.

In an apparatus of Document 1, a foreign matter is detected by vibration of a panel member vertically disposed in an application head (processing module) such that the panel member can be vertically moved.

In an apparatus of Document 2, a foreign matter is detected by the rotation of a detector rotatably disposed about a rotation shaft.

Expected foreign matters include broken pieces of glass, pieces of resin and pieces of metal, having a variety of shape and hardness. However, in the apparatus of Document 1, it may not be easy for the panel member to ride on a foreign matter depending on a shape of the foreign matter. For instance, if the foreign matter on the surface of the substrate has a perpendicular end surface, the perpendicular end surface may be abutted against a side surface of the panel member, in which case upward force is not applied to the panel member. This may cause the surface of the substrate to be damaged or the panel member or other parts of the apparatus to be damaged. Even if the panel member rides on the foreign matter, the panel member will subsequently be relatively moved with a lower end of the panel member sliding on the foreign matter. Therefore, this may also cause the surface of the substrate to be damaged. Such a problem may also happen to the apparatus of Document 2.

### BRIEF SUMMARY OF THE INVENTION

The present invention relates to an apparatus that processes a surface of a substrate to be processed. The apparatus includes a holder holding the substrate on a plane, a processing module opposed to the plane, a moving mechanism and a detection mechanism. The processing module performs processing of the surface of the substrate. The moving mechanism relatively moves the processing module with respect to the substrate in a direction of movement parallel to the plane. The detection mechanism includes a (first) roller, a (first) supporter and a (first) rotation sensor. The roller has a (first) rotation axis parallel to the plane and intersects the direction of movement. The supporter connects the roller to the processing module and supports the roller such that the roller is disposed near the plane and such that the roller can be rotated about the rotation axis and can be displaced in a direction intersecting the plane.

If there is a foreign matter or a raised portion in the surface of the substrate, the roller is rotated upon contacting the foreign matter or the raised portion. The rotation is detected by the rotation sensor. In this arrangement, the foreign matter or the raised portion can be surely detected. Moreover, the rotation axis is displaced according to the shape, etc. of the foreign matter or the raised portion as the roller rides on the foreign matter or the raised portion. By this arrangement, the substrate and the detection mechanism can be prevented from being damaged.

Preferably, an outer peripheral surface of the roller is a circular cylindrical surface with the rotation axis being a central axis of the circular cylindrical surface. When abutted against the foreign matter or the raised portion, the roller can surely ride on the foreign matter or the raised portion. Furthermore, the roller rolls on the foreign matter or the raised portion. By this arrangement, the substrate and the detection mechanism can surely be prevented from being damaged.

Preferably, the supporter has a support part and a connecting part. The support part supports the roller such that the roller can be rotated about the rotation axis. The connecting part connects the support part to the processing module such that the support part can be rotated about a support axis parallel to the rotation axis. Rotation of the support part about the support shaft causes the rotation axis to be displaced in a direction intersecting the plane.

Preferably, the apparatus further includes a controller. When a rotation angle detected by the rotation sensor exceeds a threshold value, the controller stops the moving mechanism. By this arrangement, the substrate and the detection mechanism can be further surely prevented from being damaged.

Preferably, the detection mechanism further includes a displacement sensor. The displacement sensor detects displacement of the rotation axis in a direction intersecting the plane. By this arrangement, even when the foreign matter or the raised portion has a shape which does not allow the roller to be easily rolled thereon (when the foreign matter has a shape of a needle extending in the direction of movement, for example), displacement of the rotation axis caused by the foreign matter or the raised portion can be detected by the displacement sensor. Thus, the foreign matter or the raised portion can be surely detected.

Preferably, the detection mechanism further includes a second roller, a second supporter and a second rotation sensor. The second roller has a second rotation axis parallel to the first rotation axis. The second roller is offset with respect to the first roller in a direction orthogonal to the first rotation axis. The second supporter connects the second roller to the processing module and supports the second roller such that the second roller is disposed near the plane and such that the second roller can be rotated about the second rotation axis and can be displaced in a direction intersecting the plane. When the foreign matter or the raised portion exists in a location corresponding to the first roller, the first roller is rotated and the rotation is detected by the first rotation sensor. When the foreign matter or the raised portion exists in a location corresponding to the second roller, the second roller is rotated and the rotation is detected by the second rotation sensor. This arrangement allows for a wide range of detection.

Preferably, the first roller and the second roller are arranged in a direction intersecting the direction of movement. When the foreign matter or the raised portion exists in a location corresponding to the first roller in the direction intersecting the direction of movement, the foreign matter or the raised portion can be detected by the first rotation sensor. When the foreign matter or the raised portion exists in a location corresponding to the second roller in the direction intersecting the direction of movement, the foreign matter or the raised portion can be detected by the second rotation sensor. Therefore, a general location of the foreign matter or the raised portion on the substrate can be easily detected. The foreign matter can be efficiently removed. The raised portion can be efficiently corrected. Down time of the surface processing can be shortened. Since respective lengths of the first and second rollers can be shortened, assembly accuracy can be enhanced. Gaps between the roller s and the plane, and therefore gaps between the rollers and the substrate can be made sufficiently narrow. Therefore, the foreign matter or the raised portion can surely be detected even if the foreign matter or the raised portion is small.

The first roller may be disposed on one side of the processing module in the direction of movement and the second roller may be disposed on the other side of the processing module in the direction of movement. In this arrangement, when the processing module is relatively reciprocally moved with respect to the substrate, regardless whether the processing module is moved in a to-direction or a fro-direction, either one of the first and the second roller is always located in front of the processing module in the direction of movement. The foreign matter or the raised portion existing in front in the direction of movement can be detected. Therefore, the processing module can be surely prevented from contacting the foreign matter or the raised portion before the roller. The processing module and the substrate can be further surely prevented from being damaged. The first roller and the second roller may be disposed at the same location in the direction intersecting the direction of movement. The first roller and the second roller may be disposed offset in the direction intersecting the direction of movement.

### BRIEF DESCRIPTION OF THE DRAWINGS

FIG. 1 is a perspective view of a surface processing apparatus according to an embodiment of the present invention,

FIG. 2 is a side view of the surface processing apparatus.

FIG. 3 is an explanatory plan view of a processing module of the surface processing apparatus.

FIG. 4 is a side view taken along line IV-IV of FIG. 3, providing an explanatory view of a detection mechanism of the surface processing apparatus.

FIG. 5(a) is a side view showing the roller before reaching a foreign matter.

FIG. 5(b) is a side view showing the roller abutted against the foreign matter.

FIG. 5(c) is a side view showing the roller riding on the foreign matter.

FIG. 5(d) is a side view showing the roller rolling on the foreign matter.

### DETAILED DESCRIPTION OF THE PREFERRED EMBODIMENT

An embodiment of the present invention is described below.

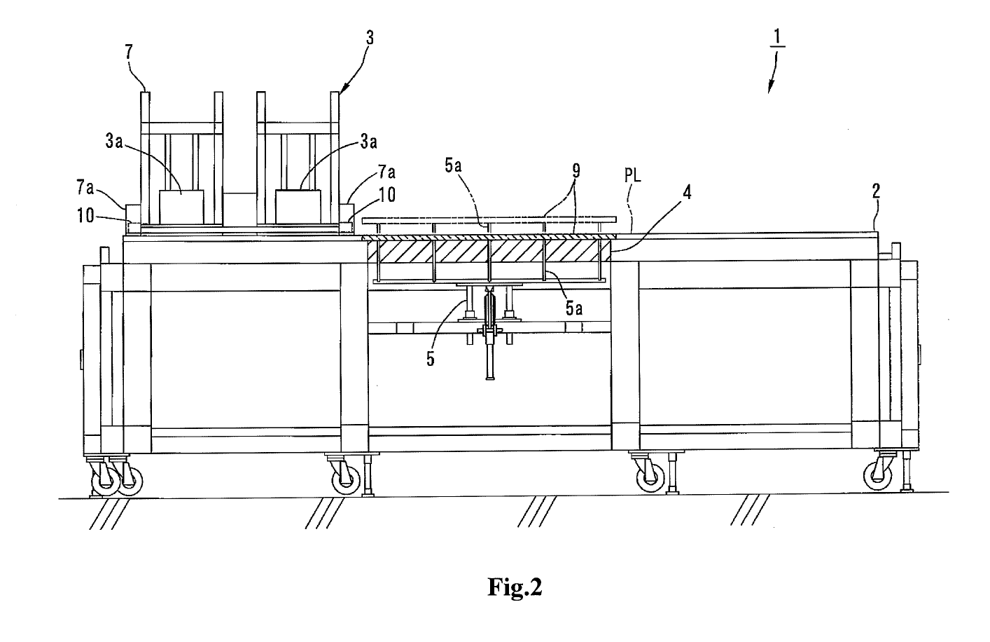

As shown in FIG. 2, a substrate 9 to be processed in this embodiment is a glass substrate for flat panel displays such as liquid crystal displays. The substrate 9 has a rectangular (quadrangular) thin plate configuration in plan view.

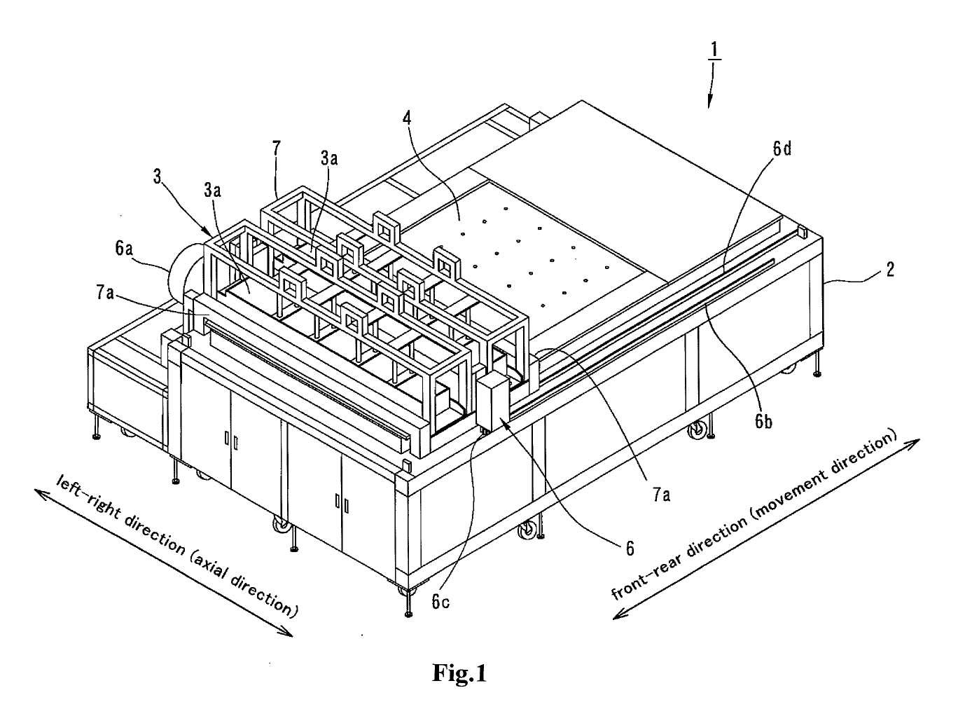

FIG. 1 shows an apparatus 1 for processing a surface of the substrate 9. The apparatus 1 is presented as a normal pressure plasma processing apparatus that performs plasma processing under a generally atmospheric pressure. However, the apparatus 1 is not limited to be a normal pressure plasma processing apparatus, and may be a vacuum plasma processing apparatus that performs plasma processing under a vacuum pressure. The apparatus 1 may be of a type that performs surface processing without using plasma. Application of the apparatus 1 may include, but not limited to, hydrophobization, hydrophilization, and other kinds of surface property modification of the substrate 9. The apparatus 1 may be used for various kinds of surface processing such as drying, cleaning, etching, ashing, film deposition and sputtering. The present invention may also be applied to a slit-coating type coating apparatus in which coating liquid such as resist or slurry is dispensed from a slit. The present invention may also be applied to a UV processing apparatus which has an ultraviolet lamp and may be used for cleaning of a surface of a substrate. The present invention may also be applied to an ozone processing apparatus that performs ashing on a surface of a substrate using ozone supplied by an ozonizer. The present invention may also be applied to a hydrofluoric acid vapor treatment system that performs etching on a surface of a substrate with vaporized hydrofluoric acid after vaporizing solution of hydrofluoric acid.

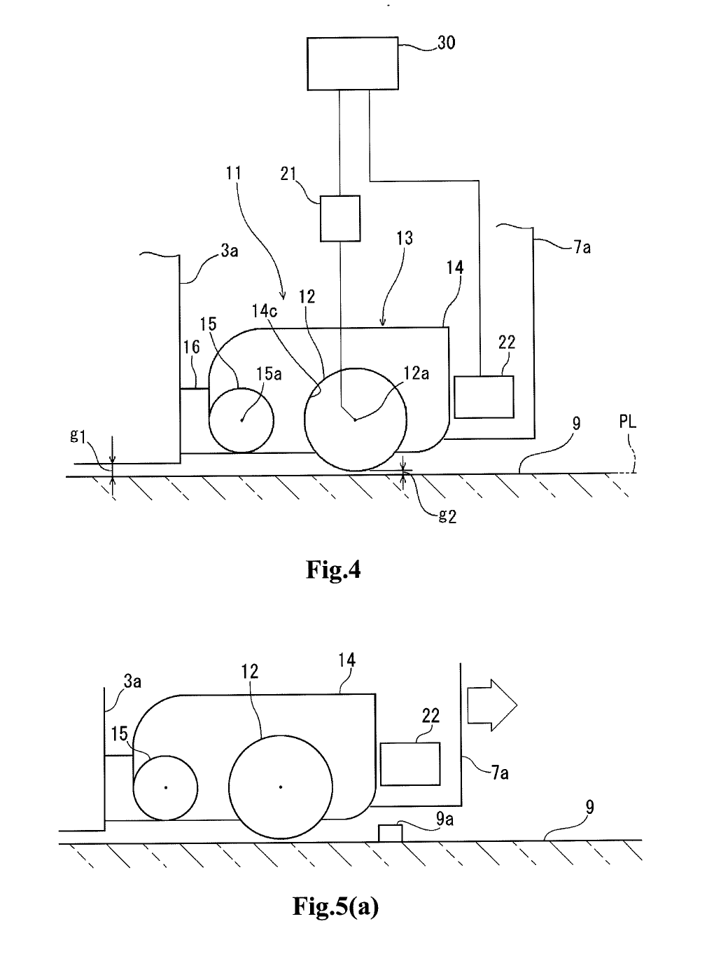

As shown in FIGS. 1 and 2, the apparatus 1 includes a base table 2 and a processing module 3. The base table 2 is disposed with a longitudinal direction of the base table 2 oriented in a front-rear direction (left-right direction in FIG. 2) and a width direction of the base table 2 oriented in a left-right direction (direction orthogonal to the plane of FIG. 2). A stage 4 (holder for the substrate 9) made of a quadrangular metal plate is disposed in a central portion of the base table 2 in the longitudinal direction. The stage 4 is electrically grounded via an earth wire (not shown), thereby constituting a ground electrode. The substrate 9 is horizontally set on the stage 4 for surface processing. A top surface of the substrate 9 set on the stage 4 becomes flush with a portion of a top surface of the base table 2 outside of the stage 4 in the front-rear direction and in the left-right direction. In FIGS. 2 and 4, a plane on which the top surface of the substrate 9 and the top surface of the base table 2 lie is denoted by “PL”.

As shown in FIG. 2, an up/down mechanism 5 is disposed below the stage 4. The up/down mechanism 5 includes a plurality of up/down pins 5a. The up/down pins 5a can protrude upward through the stage 4 as shown by chain double-dashed lines in FIG. 2 and can be encased inside the stage 4 as shown by solid lines in FIG. 2.

To set the substrate 9 on the stage 4, the up/down pins 5a are protruded from the stage 4 as shown by chain double-dashed line in FIG. 2. Then, the substrate 9 is placed on upper end portions of the up/down pins 5a using a forked manipulator or the like (not shown). Then the up/down pins 5a are lowered to be encased in the stage 4, thereby placing the substrate 9 on a top surface of the stage 4. Though not shown in the drawings, at least some of the up/down pins 5a are provided with contact adjusters (see International Publication No. WO2007/077765, for example). The contact adjusters allow upper ends of the up/down pins 5a to be contacted with an under surface of the substrate 9 without lifting the substrate 9 on the stage 4. The contact adjusters are composed of elastic members such as coil springs upwardly biasing the up/down pins 5a. The apparatus 1 includes a suction mechanism (not shown) including a suction groove formed in the stage 4 and a vacuum pump connected to the suction groove. The substrate 9 can be sucked to the stage 4 by the suction mechanism.

After the surface processing, release gas is supplied to the suction groove to release the substrate 9 from suction adherence to the stage 4. The release gas may be rare gas such as helium and argon. The inert gas may be nitrogen, oxygen, clean dry air (CDA), etc. The inert gas may be mixed gas composed of two or more gases listed above. Subsequently, the up/down pins 5a are upwardly protruded from the stage 4 to lift the substrate 9. After that, the substrate 9 is removed using a forked manipulator or the like.

An outer end support member having a shape of a plate or a frame extending along the outer end portion of the substrate 9 may be used as the up/down mechanism 5 in place of the up/down pins 5a or in addition to the up/down pins 5a. The outer end support member supports an outer end portion of the substrate 9 such that the substrate 9 can be lifted and lowered.

The processing module 3 is disposed above the base table 2. The processing module 3 has a plurality (two in the drawings) of processing heads 3a and a frame 7 supporting the processing heads 3a. The processing heads 3a, each extending in the width direction of the base table 2, are arranged with respect to each other in the longitudinal direction of the base table 2. The number of the processing heads 3a in the processing module 3 is not limited to two, but may be one (single) or three or more.

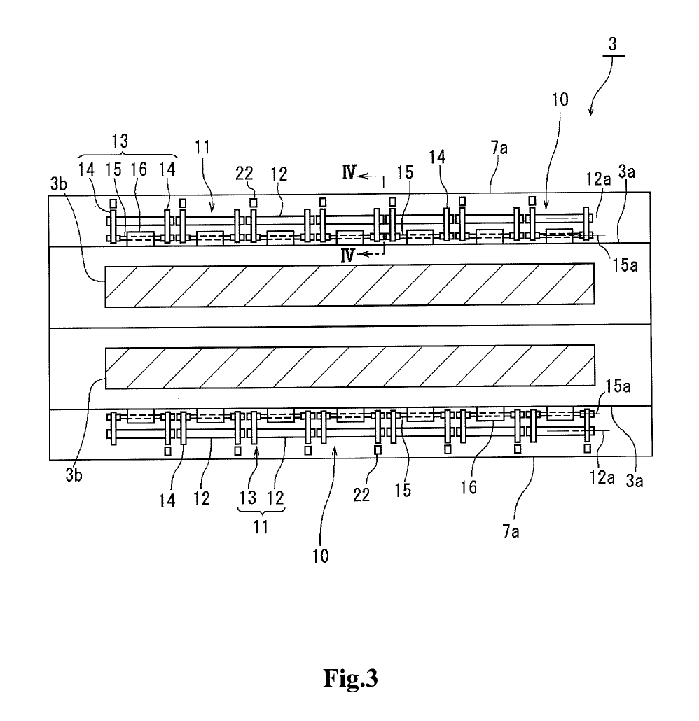

As shown in FIG. 3, an electrode 3b extending in the left-right direction is disposed inside each of the processing head 3a. A power source (not shown) is connected to the electrode 3b. The power source may supply continuous wave high frequency voltage. Alternatively, the power source may supply intermittent pulse wave voltage.

Though not shown in the drawings, a processing gas ejection passage is provided inside the processing head 3a. A processing gas source is connected to the ejection passage. The processing gas (processing fluid) from the gas source is blown out through the ejection passage toward under the processing head 3a and evenly in the width direction of the base table 2.

Components of the processing gas may be selected according to the kind of surface processing to be performed. Examples of the components of the processing gas include nitrogen, oxygen, clean dry air (CDA), perfluorocarbon (CF₄, C₂F₆ and C₃F₈, etc.), and SF₆. The processing gas may be composed of only one of the gas components mentioned above. The processing gas may be mixed gas composed of two or more of the gas components mentioned above. The components of the processing gas are not limited to those listed above. Liquid may be used in place of gas as processing fluid in some apparatus including a slit-coating type coating apparatus.

As shown in FIG. 1, the processing module 3 is supported by the base table 2 via the moving mechanism 6. The moving mechanism 6 includes a driver 6a such as a motor or engine, a guide rail 6b laid on the base table 2, a slider 6c that is disposed on the processing module 3 and slides along the guide rail 6b, a lead screw 6d that is disposed on the base table 2 parallel to the guide rail 6b, a transmission (not shown) that transmits power of the driver 6a to the lead screw 6d and a nut (not shown) that is disposed in the processing module 3 and threaded onto the lead screw 6d. The transmission may includes a gear train, a belt, a pulley, a chain or the like. The moving mechanism 6 moves the processing module 3 in a front-rear direction (direction of movement parallel to the plane PL) with respect to the base table 2, and therefore the substrate 9. The moving mechanism 6 may include a linear motor.

When the substrate 9 is set onto the stage 4 or removed form the stage 4, the processing module 3 is retreated to outside of the stage 4 in the front-rear direction by the moving mechanism 6.

When the substrate 9 is surface processed, the processing module 3 is reciprocally moved by the moving mechanism 6 in the front-rear direction between one end portion and the other end portion of the substrate 9 on the stage 4 in the front-rear direction. At the same time, the processing gas from the processing gas source is blown out of the processing gas ejection passage to a gap between the processing head 3a and the substrate 9 on the stage 4. Then voltage is supplied by the power source to the electrode 3b. This causes electric fields to be applied between the electrode 3b and the stage 4, thereby generating electrical discharge under near atmospheric pressure. This causes the processing gas between the processing head 3a and the substrate 9 to be plasmatized. The plasmatized processing gas contacts the surface of the substrate 9 to process the surface.

As shown in FIGS. 2 and 3, the apparatus 1 includes a detection mechanism 10. The detection mechanism 10 has a plurality of surface condition detection units 11. The detection units 11 are arranged in the left-right direction and received inside a horizontal frame 7a in opposite end portions (front end portion and rear end portion) of the processing module 3 in the direction of movement.

As shown in FIGS. 3 and 4, each of the surface condition detection units 11 has a roller 12 and a supporter 13 that connects the roller 12 to the processing module 3 and supports the roller 12. The roller 12 has a circular cylindrical configuration, with a central axis 12a thereof oriented in the left-right direction (direction orthogonal to the plane of FIG. 4). An outer peripheral surface of the roller 12 is a regular circular cylindrical surface with the axis 12a being the central axis of the thereof. The axis 12a is parallel to the plane PL on which the substrate 9 is placed and the axis 12a is orthogonal to (intersects with) the direction of movement (top-bottom direction in FIG. 3; left-right direction in FIG. 4) of the processing module 3.

The roller 12 may be made of resin or metal. Preferably, the roller 12 is made of a material which does not produce particles.

As shown in FIG. 3, the rollers 12 of the plurality of surface condition detection units 11 are aligned in the left-light direction inside the frame 7a in a front side (upper side in FIG. 3) of the processing module 3. In a similar manner, the rollers 12 of the plurality of surface condition detection units 11 are aligned in the left-light direction inside the frame 7a in a rear side (lower side in FIG. 3) of the processing module 3. The rollers 12 adjoining in the left-right direction are separated from each other.

Let us refer to one of the rollers 12 in each of the frames 7a as a “first roller” and another in the same frame as a “second roller”. In this case, the first roller and the second roller adjoin each other in the left-right direction (direction intersecting the direction of movement). Alternatively, one of the rollers 12 in the frames 7a in the front side (one side in the direction of movement) may be referred to as a “first roller” and one of the rollers 12 in the frames 7a in the rear side (the other side in the direction of movement) may be referred to as a “second roller”. The first roller and the second roller are offset in the direction intersecting the direction of movement or in the direction of movement. The axis 12a of the first roller is a “first rotation axis” and the axis 12a of the second roller is a “second rotation axis”.

The supporter 13 corresponding to the first roller constitutes a “first supporter”. The supporter 13 corresponding to the second roller constitutes a “second supporter”.

As shown in FIGS. 3 and 4, the supporter 13 includes a pair of support plates 14 (support parts), a support shaft 15 and a bearing bracket 16 (connecting part). The pair of support plates 14 are disposed in opposite end portions of each of the rollers 12. As shown in FIG. 4, a circular holding hole 14c is formed in each of the support plates 14. An end portion of the roller 12 is rotatably fitted into the holding hole 14c. By this arrangement, the roller 12 is supported such that the roller 12 can be rotated about the central axis 12a (rotation axis). The holding hole 14c reaches an under surface of the support plate 14. A lower end portion of the roller 12 is protruded downward from an opening at the lower end of the holding hole 14c. The lower end portion of the roller 12 is located above and near the plane PL. When the processing module 3 is in a moving position facing the substrate 9, a small gap g2 is formed between the lower end portion of the roller 12 and the substrate 9. The gap g2 is smaller than a gap g1 between the processing head 3a and the substrate 9. For example, while the g1 is about 2 to 5 mm, the g2 is about 0.5 to 4 mm when the support plate 14 is in a horizontal attitude to be described later.

A basal end portion of the support plate 14 is connected to the support shaft 15. The support shaft 15 is spaced from the roller 12 and extends parallel to the rotation axis 12a in the left-right direction. A central axis of the support shaft 15 constitutes a “support axis 15a”. The support shaft 15 is fixed in position with respect to the frame 7a via the bearing bracket 16. As shown in FIG. 3, the support shafts 15 of the plurality of surface condition detection units 11 inside the frame 7a in the front side of the processing module 3 are aligned in the left-right direction. Similarly, the support shafts 15 of the plurality of surface condition detection units 11 inside the frame 7a in the rear side of the processing module 3 are aligned in the left-right direction.

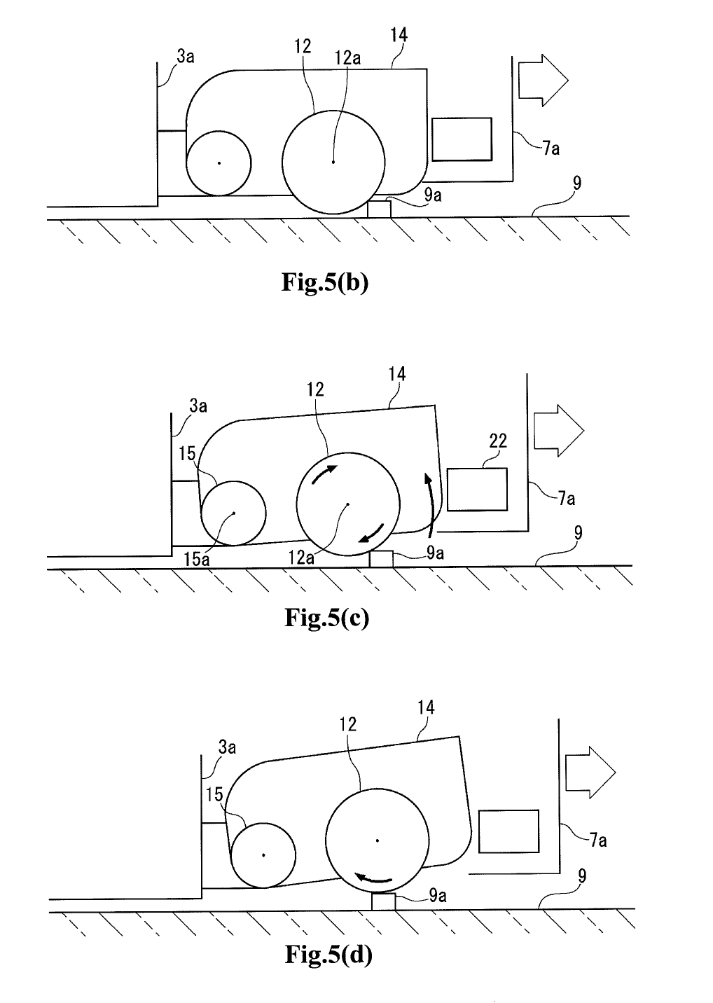

The support plate 14 is rotatable about the support shaft 15 between the horizontal attitude (FIG. 4) and an upwardly inclined attitude (see FIG. 5 (d)) in which a portion of the support plate 14 on a side opposite to the support shaft 15 is located higher. By this arrangement, the rotation axis 12a can be displaced in the top-bottom direction (direction intersecting the plane PL). Although not shown in the drawings, the detection mechanism 10 is provided with a stopper. The stopper prohibits the support plate 14 from rotating downwardly beyond the horizontal attitude (downwardly inclined attitude). The support plate 14 is normally stabilized in the horizontal attitude due to its own weight and the weight of the roller 12.

As schematically shown in FIG. 4, a rotation sensor 21 is connected to each of the rollers 12. The rotation sensor 21 may be a rotary encoder, for example, that detects rotation angle of the roller 12.

A displacement sensor 22 is provided in the frame 7a. The displacement sensor 22 is disposed so as to be opposed to a distal end portion (located on a side opposite to the support shaft 15) of the support plate 14. The displacement sensor 22 may be a contact switch or a proximity switch, for example, and detects displacement of the distal end portion of the support plate 14, and therefore displacement of the rotation axis 12a in the top-bottom direction.

The rotation sensor 21 and the displacement sensor 22 are connected to the controller 30. The controller 30 includes a microcomputer, a driving circuit for moving mechanism 6 and A/D convertor or the like. The microcomputer includes a CPU, a RAM, a ROM and an input/output interface. The controller 30 may be an analogue circuit. The controller 30 controls the moving mechanism 6, etc. based on detection signals from the rotation sensor 21 and the displacement sensor 22.

Operation of the surface processing apparatus 1 is described below, focusing on operation of the detection mechanism 10:

The surface processing of the substrate 9 is performed while reciprocally moving the processing module 3 between the one end portion and the other end portion of the substrate 9. Here, let us assume that a foreign matter 9a lies on the top surface of the substrate 9 in front of the processing module 3 in the direction of movement (direction of the outline arrow in FIG. 5(a)) as shown in FIG. 5 (a). As the processing module 3 is moved, of the plurality of the surface condition detection units 11 arranged in the left-right direction (direction orthogonal to the plane of FIG. 5), the roller 12 of the unit 11 at a location corresponding to the foreign matter 9a is abutted against the foreign matter 9a (FIG. 5(b)). This causes the roller 12 to be rotated about the rotation axis 12a. The rotation is detected by the corresponding rotation sensor 21. The detection signals are entered into the controller 30, thereby the foreign matter 9a is detected.

As shown in FIG. 5 (c), simultaneously with the rotation of the roller 12, the support plate 14 is rotated about the support axis 15a according to a shape of the foreign matter 9a. This causes the distal end portion of the support plate 14, and therefore the rotation axis 12a, to be upwardly displaced. The displacement is detected by the displacement sensor 22 and the detection signals are entered into the controller 30. By this arrangement, the foreign matter 9a can be further surely detected. Even if the foreign matter 9a has a shape that might not easily cause the roller 12 to be rotated (such as when the foreign matter has a shape of a needle extending in the direction of movement), the foreign matter 9a can surely be detected.

The roller 12, upwardly displaced as being rotated, rides on the foreign matter 9a. The shape of the foreign matter 9a seldom affects the riding. For example, when the foreign matter 9a has a vertical side surface as shown in FIG. 5, the roller 12 can surely ride on the foreign matter 9a using a corner portion between a top surface and the side surface of the foreign matter 9a as a point of support. Therefore, the foreign matter 9a can be prevented from being pushed by the roller 12, and the substrate 9 can be prevented from being damaged by friction with the foreign matter 9a. Damage to the surface condition detection unit 11 can also be prevented.

After riding on the foreign matter 9a, the roller 12 rolls on the foreign matter 9a as the processing module 3 moves (FIG. 5(d)). Therefore, it is rolling friction that is mostly generated between the foreign matter 9a and the roller 12. This can prevent the generation of sliding friction. Thus, force applied to the substrate 9 can be lessened, further preventing damage to the substrate 9. Since the rotation axis 12a can be vertically displaced, the foreign matter 9a can be prevented from being caught between and being pressed by the roller 12 and the substrate 9. Therefore, the substrate 9 can be further surely prevented from being damaged.

The rotation sensor 21, detecting not only rotation of the roller 12 as it rides on the foreign matter 9a but also the rolling of the roller 12 on the foreign matter 9a, enters detection signals into the controller 30. This enables rotation angle of the roller 12 after contacting the foreign matter 9a to be detected. When the rotation angle exceeds a threshold value, the controller 30 forces the moving mechanism 6 to stop moving the processing module 3. This further surely prevents damage to the substrate 9. Errors can be avoided by appropriately setting the threshold value.

A threshold value may also be set to a detected amount of displacement detected by the displacement sensor 22 so that the movement of the processing module 3 may be forcibly stopped when the detected amount of displacement exceeds the threshold value. The movement of the processing module 3 may be forcibly stopped when at least one of the detected amount of rotation angle and the detected amount of displacement exceeds the threshold value.

Moreover, of the surface condition detection units 11 aligned in the left-right direction, the controller 30 identifies the unit 11 in which rotation or displacement is detected and displays the identified unit 11 on a monitor (display). This enables a general location of the foreign matter 9a in the substrate 9 to be easily known, the foreign matter 9a to be efficiently removed, and down time of surface processing to be shortened.

The plurality of surface condition detection units 11 enable thorough detection of foreign matters 9a throughout a width direction (direction orthogonal to the plane of FIG. 5) of the substrate 9. On the other hand, a length of each roller 12 is sufficiently shorter than a width of the substrate 9. Therefore, assembly accuracy can be sufficiently secured and the gap g2 between the roller 12 and the substrate 9 can be sufficiently narrow. Therefore, even if the foreign matter 9a is small, the foreign matter 9a can surely be detected.

When the processing module 3 is moved in a to-direction (upward in FIG. 3), foreign matters or raised portions in front in the direction of movement can be detected by the surface condition detection unit 11 in the front side (upper side in FIG. 3) of the processing module 3. When the processing module 3 is moved in a fro-direction (downward in FIG. 3), foreign matters or raised portions in front in the direction of movement can be detected by the surface condition detection unit 11 in the rear side (lower side in FIG. 3) of the processing module 3. Therefore, the processing module 3 can be surely prevented from contacting the foreign matters or the raised portions before the detection mechanism 10. By this arrangement, the processing module 3 or the substrate 9 can be further surely prevented from being damaged.

The present invention is not limited to the embodiments described above, but various modifications can be made within the spirit or scope of the invention.

For example, in the embodiment described above, the foreign matter 9a existing on the surface of the substrate 9 was detected. However, even when the foreign matter 9a is caught between the stage 4 and the substrate 9, and the substrate 9 is raised due to the caught foreign matter, the raised portion of the substrate 9 can be detected by the detection mechanism 10. Even when a portion of the substrate 9 is raised due to a cause other than the foreign matter 9a, the raised portion can be detected by the detection mechanism 10.

The shape of the roller 12 is not limited to a regular circular cylinder, but may be an elliptic cylinder or a polygonal cylinder. The roller 12 is not limited to a solid cylinder, but may be a hollow cylinder. The length of the roller 12 in the axial direction may be smaller than a diameter of the roller 12.

The first roller and the second roller within each frame 7a may not necessarily be spaced from each other in the direction intersecting the direction of relative movement of the processing module 3 as long as the first roller and the second roller are not completely overlapped with each other in the direction intersecting the direction of relative movement of the processing module 3. The first roller and the second roller may be partially overlapped with each other when viewed from the direction of relative movement of the processing module 3.

The direction of relative movement of the processing module 3 and the axial direction of the roller 12 may not be precisely orthogonal to each other as long as they intersect with each other.

The holder is not limited to the tabular stage 4 having a horizontal surface. The holder may be a plurality of support pins or rollers. The top surface of the stage 4, i.e. a support surface for the substrate, may not be flat throughout the surface. The support surface may include protrusions or ridges and the substrate 9 may be held by the protrusions or ridges.

The plane PL on which the substrate 9 is to be placed may not be horizontal. The plane PL may be inclined with respect to the horizon or may be vertical.

Instead of being rotatably connected to the support shaft 15, the support part 14 may be disposed such that the support part can be slidably displaced in the direction intersecting the plane PL. The direction of displacement of the support part 14 may not be exactly orthogonal to the plane PL as long as the direction of displacement intersects the plane PL.

The substrate is not limited to be a glass substrate, but may be a semiconductor wafer or a flexible continuous sheet.

The processing module may be fixed in position and the moving mechanism may move the substrate. The moving mechanism may be composed of a moving stage, a floating stage, a roller conveyor, a robot arm, a manipulator or the like and may also serve as the holder that holds the substrate on the plane PL. When the substrate is a continuous sheet, the moving mechanism may be composed of a supply roll unrolling the continuous sheet and a winding roll rolling up the continuous sheet and the moving mechanism may also serve as the holder that holds the continuous substrate on the plane PL. The moving mechanism 6 may be operated by an operator.

The present invention can be applied to manufacturing of flat panel displays (FPD), for example.

What is claimed is:

1. An apparatus that processes a surface of a substrate to be processed, said apparatus comprising:
a holder holding the substrate on a plane;
a processing module that is opposed to the plane and performs the processing;
a moving mechanism that relatively moves the processing module with respect to the substrate in a direction of movement parallel to the plane; and
a detection mechanism that detects a foreign matter on the surface or a raised portion of the surface; the detection mechanism comprising:
a roller having a rotation axis parallel to the plane and intersecting the direction of movement;
a supporter connecting the roller to the processing module and supporting the roller such that the roller is disposed near the plane and such that the roller can be rotated about the rotation axis and can be displaced in a direction intersecting the plane; and
a rotation sensor that detects rotation of the roller.

2. The apparatus according to claim 1 wherein an outer peripheral surface of the roller is a circular cylindrical surface with the rotation axis being a central axis of the circular cylindrical surface.

3. The apparatus according to claim 1 wherein the supporter has
a support part supporting the roller such that the roller can be rotated about the rotation axis, and
a connecting part connecting the support part to the processing module such that the support part can be rotated about a support axis parallel to the rotation axis.

4. The apparatus according to claim 1 further comprising a controller that stops the moving mechanism when a rotation angle detected by the rotation sensor exceeds a threshold value.

5. The apparatus according to claim 1 wherein the detection mechanism further comprising a displacement sensor that detects displacement of the rotation axis in a direction intersecting the plane.

6. An apparatus that processes a surface of a substrate to be processed, comprising:
a holder holding the substrate on a plane;
a processing module that is opposed to the plane and performs the processing;
a moving mechanism that relatively moves the processing module with respect to the substrate in a direction of movement parallel to the plane; and
a detection mechanism that detects a foreign matter on the surface or a raised portion of the surface;
the detection mechanism comprising:
a first roller having a first rotation axis parallel to the plane and intersecting the direction of movement;
a first supporter connecting the first roller to the processing module and supporting the first roller such that the first roller is disposed near the plane and such that the first roller can be rotated about the first rotation axis and can be displaced in a direction intersecting the plane;
a first rotation sensor that detects rotation of the first roller;
a second roller having a second rotation axis parallel to the first rotation axis, the second roller being offset with respect to the first roller in a direction orthogonal to the first rotation axis;
a second supporter connecting the second roller to the processing module and supporting the second roller such that the second roller is disposed near the plane and such that the second roller can be rotated about the second rotation axis and can be displaced in a direction intersecting the plane; and
a second rotation sensor that detects rotation of the second roller.

7. The apparatus according to claim 6 wherein the first roller and the second roller are arranged in a direction intersecting the direction of movement.

8. The apparatus according to claim 6 wherein the first roller is disposed on one side of the processing module in the direction of movement and the second roller is disposed on the other side of the processing module in the direction of movement.
